(19) United States
(12) Patent Application Publication
(10) Pub. No.: US 2003/0090515 A1
(43) Pub. Date: May 15, 2003

(54) Simplified user interface by adaptation based on usage history

(75) Inventors: Matthew S. Chang, San Diego, CA (US); Mark Kenneth Eyer, Kirkland, WA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Nicholas Colsey, Del Mar, CA (US); Brant L. Candelore, Escondido, CA (US); Dayan Ivy Golden, San Diego, CA (US)

Correspondence Address: ROGITZ & ASSOCIATES, 750 B STREET, SUITE 3120, SAN DIEGO, CA, 92101, US

(73) Assignee: Sony Corporation and Sony Electronics Inc.

(21) Appl. No.: 10/054,463

(22) Filed: Nov. 13, 2001

(51) Int. Cl. G09G 5/00

(52) U.S. Cl. 345/745

(57) ABSTRACT

An adaptive user interface and method thereof for simplifying the use of new electronic devices, such as set top boxes, by adapting the user interface on the basis of usage history. The adaptive user interface monitors input commands to the user interface and tracks usage statistics for use in determining whether to add or remove features from the interface. A ramp-up embodiment of the invention automatically adds user interface features as the user becomes more proficient with a device. A ramp-down embodiment of the invention automatically removes seldom used interface features. By tracking users' actions, the user interface can more accurately be modified to fit actual use habits of each user, rather than relying on user perception of what functionality is used.

### BACKGROUND OF THE INVENTION

1. Field of the Invention

The present invention relates generally to an apparatus and method to simplify using new consumer electronic devices by adapting the user interface on the basis of usage history.

2. Description of the Related Art

Many home electronic devices have user configurable displays. These devices include set-top boxes (STBs), televisions, computers, VCRs, DVDs, digital stereo systems, etc . . . The interfaces for these devices are generally configured based on preferences determined by the manufacturer. In addition, different devices often use different terminology to describe similar functions. Furthermore, as these devices evolve more features are added into each generation.

Although user interfaces are designed for ease of use, the recent proliferation of these devices and the number of varied interfaces, can confuse and intimidate users. For example, many people have VCRs that flash 12:00 simply because they have not set the clock. Often, users learn only a few of the features of a device. In addition, many users are not even aware of all of the features of their devices. Furthermore, many people feel that sitting down and reading the instructions is simply not worth the effort. Compounding this problem is that some of the more complex devices have instruction manuals that are several hundred pages thick.

In order to simplify using these devices, some user interfaces now have demonstration modes that cycle through the various features of the device. Also, user interfaces often contain a hierarchy of menus that group features by related functionality. Other devices allow the user to manually configure the user interface.

Moreover, users tend to develop a set of favorite features for each particular device. There is now way to determine a priori which features a particular user will want to use. Some users want ready access to only those features that are absolutely necessary to operate the device and do not want to see the other features. Other users want access to all of the features, all of the time.

Therefore, a need exists for determining those features of a device which a particular user wants access to through the user interface on a user-by-user individual basis. In addition, a need exists for modifying the user interface to reflect the user's desired features. Moreover, in order to familiarize the user with all of a device's features and build proficiency, there is a need for a means to slowly teach the user the features of the device.

### OBJECTS OF THE INVENTION

It is therefore an object of the present invention to simplify using new electronic devices by adapting the user interface on the basis of usage history, rather than on preset or user selected criteria.

It is another object of the present invention to adapt the features displayed on a user interface to add features as the user becomes more proficient in operating an electronic device.

It is still another object of the present invention to adapt the features displayed on a user interface to eliminate unused features to simplify operation of an electronic device.

Other objects and advantages of the invention will in part be obvious and will in part be apparent from the specification and the drawings.

### SUMMARY OF THE INVENTION

To attain the above-mentioned object, the invention provides a method of adapting a user interface for simplifying use of an electronic device. The method initially configures a display on the user interface with a plurality of features of the electronic device. The method then monitors usage of each of the plurality of features by the user of the electronic device and generates usage statistics based on the monitored usage. If there is more than one user, the method monitors usage on a user-by-user profile basis. The plurality of features are then adapted on the basis of the generated statistics and the display is reconfigured with the adapted plurality of features. Further, the method can prompt the user to accept or reject changes to the plurality of features prior to reconfiguring the display.

A first embodiment of the invention is a method that includes adding features to the plurality of features when the generated statistics indicate the user has achieved a predetermined level of proficiency.

A second embodiment of the invention is a method that removes features from the plurality of features when the generated statistics indicate the user infrequently accesses the features to be removed.

To further attain the above-mentioned object, the invention also provides an adaptable user interface for simplifying use of an electronic device. The adaptable user interface has a display for displaying a plurality of features of the electronic device. An input means is provided for inputting commands corresponding to the displayed plurality of features. A monitoring means monitors usage of each of the plurality of features by the user of the electronic device. A generating means next generates usage statistics based on the monitored usage and an adapting means adapts the plurality of features on the basis of the generated statistics. A reconfiguring means then reconfigures the display with the adapted plurality of features. Further, the display can prompt the user to accept or reject changes to the plurality of features prior to the reconfiguring means reconfiguring the display.

A third embodiment of the invention is an adaptable user interface that adds features to the plurality of features when the generated statistics indicate the user has achieved a predetermined level of proficiency.

A fourth embodiment of the invention is an adaptable user interface that removes features from the plurality of features when the generated statistics indicate the user infrequently accesses the features to be removed.

### BRIEF DESCRIPTION OF THE DRAWINGS

For a more complete understanding of the invention, reference is made to the following description and accompanying drawings, in which:

FIG. 1 is a system block diagram of a system using a set-top box;

FIG. 2 is a functional block diagram of a digital set-top box suitable for use with the present invention;

FIG. 3 is an illustration of adding and removing exemplary features on an onscreen display (OSP) user interface according to the present invention; and

FIG. 4 is a flowchart showing the process of adding and removing exemplary features on a user interface according to the present invention.

### DETAILED DESCRIPTION OF PREFERRED EMBODIMENTS

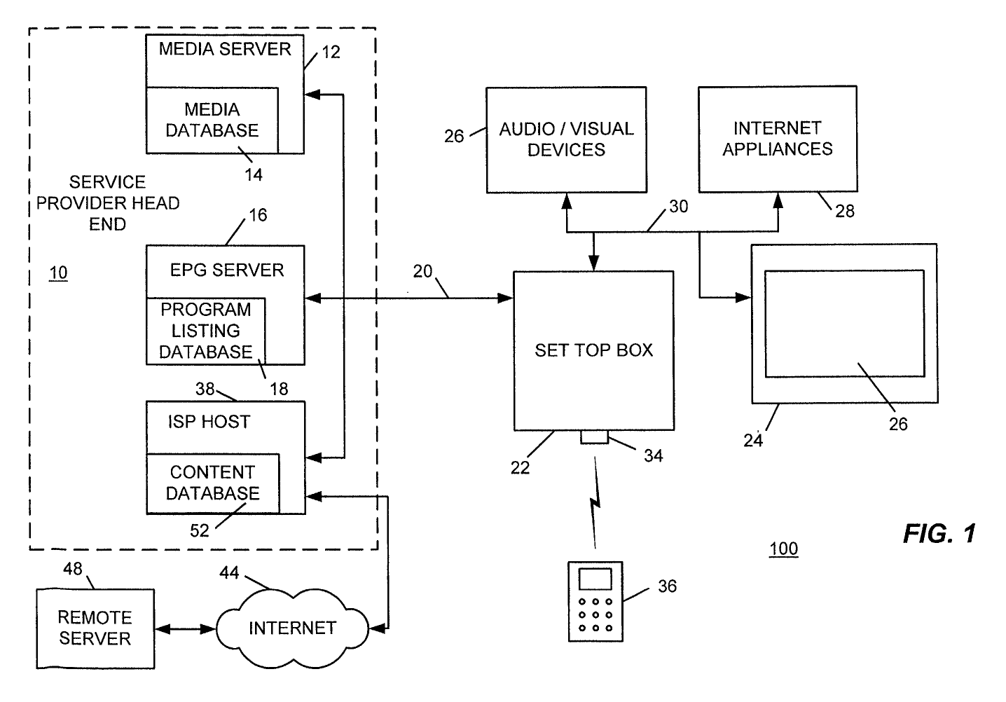

The preferred embodiments of the apparatus and method according to the present invention will be described with reference to the accompanying drawings. Referring to FIG. 1, a block diagram for an exemplary interactive cable or satellite television (TV) system 100 is shown. Such a system 100 is typical of the type of end-user device to which the present invention can be applied. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media—one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to a set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc . . . The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc . . . Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's AperiosTm real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc . . . In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

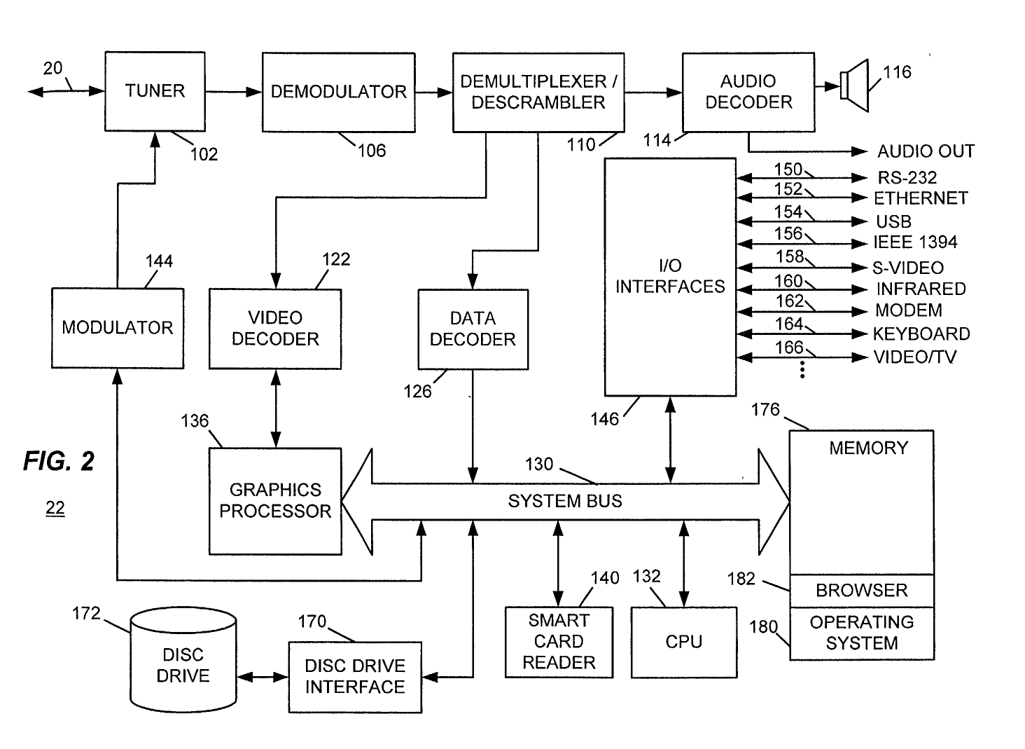

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (0013) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc . . .

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc . . . CPU 132, in order to operate as a computer, is coupled through the system bus 130 to memory 176. Memory 178 may include a combination any suitable memory technology including Random Access Memory (RAM), Read Only Memory (ROM), Flash memory, Electrically Erasable Programmable Read Only Memory (EEPROM), etc . . .

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modern STBs have generally evolved to include a next layer referred to as “middleware”. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

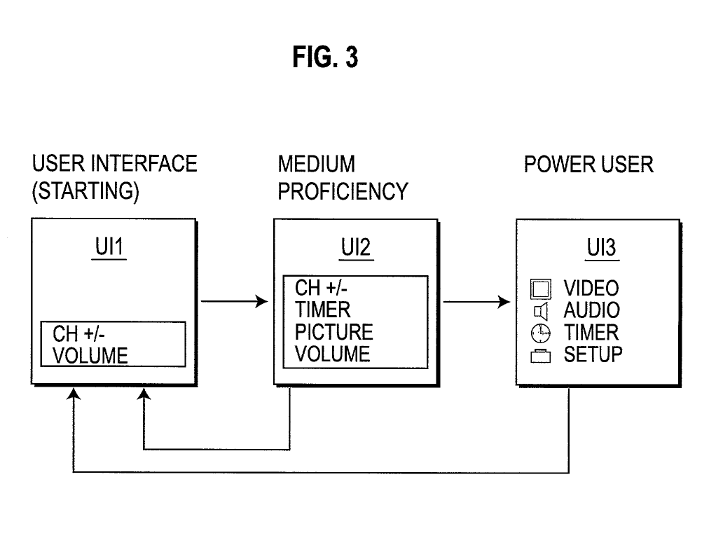

FIG. 3 is an illustration of adding and removing exemplary features on a user interface for an electronic device according to the present invention. The user interfaces shown in FIG. 3 correspond to graphical interfaces that can be displayed to a user on some type of display device. Typically, such displays include televisions, computer monitors, PDAs, remote controls, cell phones, etc . . . For example, as shown in FIG. 1, the display may correspond to a television on-screen menu display (OSD) 26. FIG. 3 illustrates three user interfaces of varying complexity. User interface UI1 is the simplest user interface and may be programmed as a starting display configuration. User interface UI simply shows the core functions of channel up/down and volume up/down. User interface UI2 is a more complex interface that provides additional features that may be desired by a moderately proficient user. UI2 shows timer and picture features added to the channel and volume features of UI1. User interface UI3 contains numerous features that may be desired by a very proficient user (i.e. a ‘power’ user). UI3 shows audio and setup features added to UI2 and may additionally include various sub-menus for accessing other features. The number and types of features that can be configured as part of a user interface is dependent on the electronic device itself. Some devices have a minimal number of features that can be displayed, while others offer thousands of features that may be configured into dozens of sub-menus. The present invention is not limited to the user interfaces shown in FIG. 3 and should not be interpreted as being limited by these example interfaces.

The present invention is an adaptable user interface and method thereof for simplifying the use of new electronic devices, such as set-top boxes, by adapting the user interface on the basis of usage history. A ramp-up embodiment of the invention automatically adds user interface features as the user becomes more proficient with a device. A ramp-down embodiment of the invention automatically removes seldom used user interface features. The adaptable user interface monitors input commands to the user interface and tracks usage statistics for use in determining whether to add or remove features from the interface. In this manner, the user interface facilitates learning of the features of the device and automatically adjusts the displayed features according to the user's preferences.

The ramp-up embodiment of the present invention is an adaptable user interface for simplifying use of an electronic device. The adaptable user interface includes a display for displaying a plurality of features of the electronic device. An input means is used for inputting commands corresponding to the displayed plurality of features. A monitoring means is provided for monitoring usage of each of the plurality of features by the user of the electronic device. A generating means generates usage statistics based on the monitored usage. An adapting means adds features to the plurality of features when the generated statistics indicate the user has achieved a predetermined level of proficiency. A reconfiguring means then reconfigures the display with the adapted plurality of features.

Similarly, the ramp-down embodiment of the present invention is an adaptable user interface for simplifying use of an electronic device. The adaptable user interface includes a display for displaying a plurality of features of the electronic device. An input means is used for inputting commands corresponding to the displayed plurality of features. A monitoring means is provided for monitoring usage of each of the plurality of features by the user of the electronic device. A generating means generates usage statistics based on the monitored usage. An adapting means removes features from the plurality of features when the generated statistics indicate the user does not access the features to be removed. A reconfiguring means then reconfigures the display with the adapted plurality of features.

Further features for either embodiment of the present invention include that the display can optionally prompt the user to enable the adapting means, thereby placing the user interface into a learning or simplifying mode. The display may also prompt the user to accept or reject changes to the plurality of features prior to the reconfiguring means reconfiguring the display. The input means may additionally include a configuring command whereby the user manually adapts the plurality of features for display. The input means can be integrated into the electronic device or the display, or be a remote control for use with the electronic device. The electronic device itself may be a set-top box.

In the present invention, the adjustment of displayed features is defined to include inserting (adding) and/or deleting (removing) specific functions, commands, or operations from one or more displayed menus. Other types of adjustments, such as fading, dimming, locking-out, or shifting features between menus, are considered as nonessential value-added features that could be incorporated into this invention.

The generated usage statistics track the user's use of all the features of a device or of only the displayed features. Statistics can be generated on a particular feature, sub-set of features, or for all the features. Exemplary usage statistics are: the number of times a feature is used, the frequency of use, use relative to certain other features, use compared to a predetermined metric, etc . . . The above description is intended only to provide examples of usage statistics and should not be interpreted as limiting the present invention to only these examples.

In the case of multiple users of a device, since each user will have different viewing habits individual sets of statistics are compiled for each user. The individual user sets are stored in a memory, which may be a removable memory such as a Sony MemoryStick™. A removable memory allows the settings for each user to be moved from one device to another.

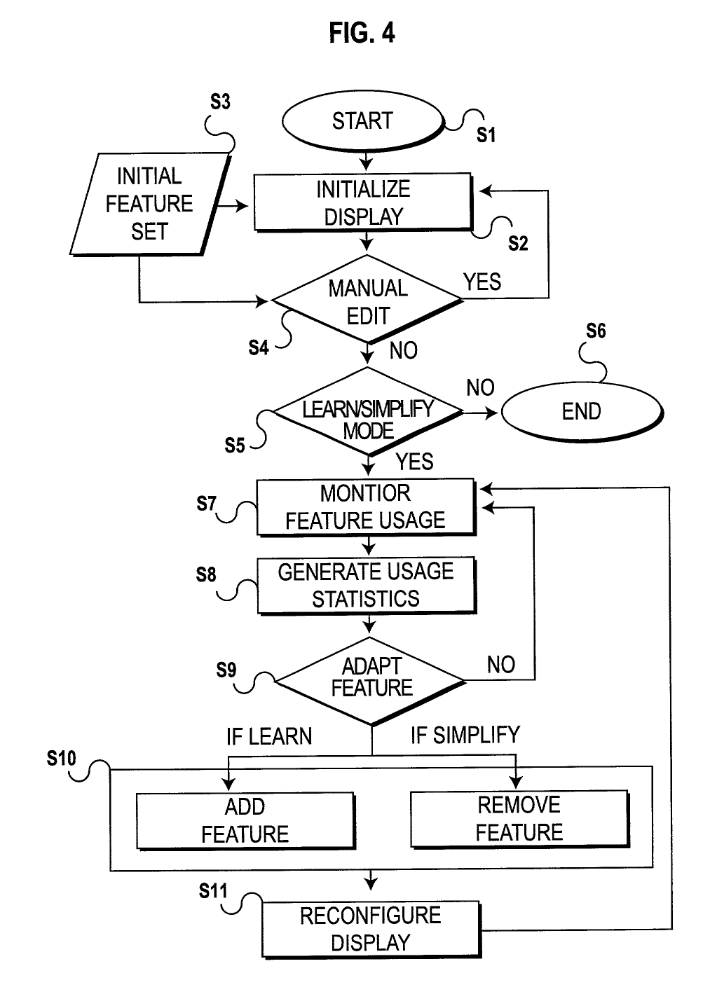

FIG. 4 is a flowchart showing the process of adding and removing exemplary features on a user interface according to the present invention. Step S1 is simply the start of the process and may correspond to turning the device on. In step S2, the user interface display is initialized based on a stored initial set of features S3. At this point, the user has an option to manually edit S4 the displayed features. If the user chooses to edit the display, features can be added and/or deleted and the display returns to step S2 to reinitialize the display with the new features. The stored initial feature set is also updated with the new features. If the user chooses not to edit the features, the invention proceeds to step S5. The user is then prompted as to whether the user interface should be placed in a learn or simplify mode. If the user elects not to place the user interface into either the learn or simplify modes, the process ends S6. If the user does elect either the learn or simplify mode, monitoring of the feature usage commences S7. Next, statistics are generated S8 based on the monitored usage. At some point, the usage statistics will indicate that at least one feature should be changed. This indication is based on the statistics meeting some predetermined usage criteria. The user is then prompted as to whether the user interface should be adapted based on the indicated feature(s) S9. If the user indicates that no change should be made the process returns to step S7 and the usage continues to be monitored. If the user indicates the change should be made the invention proceeds to step S10. If learn mode was previously selected the change involves adding the indicated feature(s). If simplify mode was previously selected the change involves deleting the indicated feature(s). In step S11, the user interface is reconfigured based on the modified features and displayed. The process then returns to step S7 and monitoring continues.

The following example illustrates the operation of the present invention. A user purchases a new set-top box (STB) that is equipped with the present invention. The user connects the STB to his television and intends to use it as a digital recorder for his favorite television programs. When the user first turns on the STB the box displays on the television screen a menu of features based on a factory preset feature set. One of the features is an option to customize the setup. This allows the user to essentially add or remove features and customize the menus. Another feature is the option to place the user interface in either a learn or simplify mode. Since the user is unfamiliar with the STB and only wishes to use the digital recorder function he places the STB in simplify mode. The next few times the STB is used, the invention monitors which features the user accesses and periodically prompts the user as to whether certain unused or seldom used features should be removed from the user interface. Eventually, all of the extraneous features will have been removed. This will allow the user to quickly use the digital recording capability of the STB. After some time, the user may decide to learn some of the other capabilities of the STB, so the user places the STB in the learn mode. This mode again monitors his usage, but now periodically prompts the user as to additional features that might be useful to have displayed in the user interface. As features are added, the user becomes more knowledgeable about the capabilities of the STB. This increases the user's proficiency with the user interface and eventually becomes a ‘power’ user.

While the preferred embodiments of the present invention have been described using specific terms, such description is for illustrative purposes only, and it is to be understood that changes and variations may be made without departing from the spirit or scope of the appended claims.

What is claimed is:

1. A method of adapting a user interface for simplifying use of a consumer electronic device, comprising the steps of:
initially configuring a display on said user interface with a plurality of features of said consumer electronic device;
monitoring usage of each of said plurality of features by the user of said consumer electronic device; said monitoring step generating usage statistics on a user-by-user basis based on the monitored usage;
adapting said plurality of features on the basis of the usage; and
reconfiguring said display with the adapted plurality of features.

2. The method of adapting a user interface according to claim 1, wherein said adapting step adds features to said plurality of features when the generated statistics indicate the user has achieved a predetermined level of proficiency.

3. The method of adapting a user interface according to claim 1, wherein said adapting step removes features from said plurality of features when the generated statistics indicate the user infrequently accesses the features to be removed.

4. The method of adapting a user interface according to claim 1, further comprising the step of prompting the user to accept or reject changes to said plurality of features prior to reconfiguring said display.

5. The method of adapting a user interface according to claim 1, wherein the user manually adapts said plurality of features for display.

6. The method of adapting a user interface according to claim 2, further comprising the step of prompting the user to enable said adapting step, thereby placing said user interface into a learning mode.

7. The method of adapting a user interface according to claim 3, further comprising the step of prompting the user to enable said adapting step, thereby placing said user interface into a simplifying mode.

8. An adaptable user interface for simplifying use of a consumer electronic device, comprising:
a display for displaying a plurality of features of said consumer electronic device;
input means for inputting commands corresponding to the displayed plurality of features;
monitoring means for monitoring usage of each of said plurality of features by the user of said consumer electronic device;
generating means for generating usage statistics based on the monitored usage;
adapting means for adapting said plurality of features on the basis of the usage; and
reconfiguring means for reconfiguring said display with the adapted plurality of features.

9. The adaptable user interface according to claim 8, wherein said adapting means adds features to said plurality of features when the generated statistics indicate the user has achieved a predetermined level of proficiency.

10. The adaptable user interface according to claim 8, wherein said adapting means removes features from said plurality of features when the generated statistics indicate the user infrequently accesses the features to be removed.

11. The adaptable user interface according to claim 8, wherein said display prompts the user to accept or reject changes to said plurality of features prior to said reconfiguring means reconfiguring said display.

12. The adaptable user interface according to claim 8, wherein said input means includes a configuring command whereby the user manually adapts said plurality of features for display.

13. The adaptable user interface according to claim 8, wherein said consumer electronic device is a set-top box.

14. The adaptable user interface according to claim 8, wherein said input means is integrated into said consumer electronic device.

15. The adaptable user interface according to claim 8, wherein said input means is a remote control for use with said consumer electronic device.

16. The adaptable user interface according to claim 8, wherein said input means is integrated with said display.

17. The adaptable user interface according to claim 9, wherein said display prompts the user to enable said adapting means, thereby placing said user interface into a learning mode.

18. The adaptable user interface according to claim 10, wherein said display prompts the user to enable said adapting means, thereby placing said user interface into a simplifying mode.
